(19) United States
(12) Patent Application Publication
(10) Pub. No.: US 2005/0269452 A1
(43) Pub. Date: Dec. 8, 2005

(54) Vehicle safety

(76) Inventor: Glenn Mark Wakefield, Tempe, AZ (US)

Correspondence Address: Glenn Wakefield, 1416 East Carmen Street, Tempe, AZ, 85283-4142, US

(21) Appl. No.: 10/998,295

(22) Filed: Nov. 27, 2004

Related U.S. Application Data
(60) Provisional application No. 60/526,001, filed on Nov. 29, 2003.
(60) Provisional application No. 60/535,280, filed on Jan. 10, 2004.

(51) Int. Cl. B64C 1/10

(52) U.S. Cl. 244/121

(57) ABSTRACT

Toughened airbag systems are applied to the bottom surface of an aircraft to permit the crashing vehicle to land on a cushion of air. Shock absorber systems fitted to aircraft seats allow a more gradual deceleration of the occupant. A bumper system is applied to ground vehicles/trains to allow a more gradual deceleration of the vehicle/train and to minimize injury to pedestrians.

### CROSS-REFERENCE TO RELATED APPLICATIONS

Provisional application No. 60/526,001, filed November 2003.

Provisional application No. 60/535,280, filed January 2004.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This patent application applies to the field of vehicle safety and electromechanical devices.

Ground and air vehicles have various safety features to prevent accidents and to minimize injury on crashing. Safety belts, airbags, bumpers and crumple zone technology are standard features found on ground vehicles. Electronic vision systems, electronic warning systems and active control devices for ground vehicles are currently under development. Safety belts, crumple zone technology, electronic warning systems and active control devices are standard features found on large commercial aircraft.

### BRIEF SUMMARY OF THE INVENTION

Toughened airbag systems are applied to the bottom surface of an aircraft to permit the crashing vehicle to land on a cushion of air. Shock absorber systems fitted to aircraft seats allow a more gradual deceleration of the occupant. A bumper system is applied to ground vehicles/trains to allow a more gradual deceleration of the vehicle/train and to minimize injury to pedestrians.

### BRIEF DESCRIPTION OF THE SEVERAL VIEWS OF THE DRAWING

Not Applicable

### DETAILED DESCRIPTION OF THE INVENTION

1. Deceleration of Aircraft/Spacecraft/Object (i.e. Fixed Wing, Rotary Wing, Airship, Satellite, Spaceship) by an Airbag System and/or Shock Absorber System

In general aircraft/spacecraft/object crash survivability may be improved by decreasing the speed of impact and by limiting the rate of deceleration on impact. A pilot/autopilot in the process of crashing an aircraft/spacecraft/object usually retains some degree of control over the descent. Once it is realized that crashing is imminent, the airbag system may be implemented by activating a mechanism for inflating the external airbags (i.e. high flow rate air compressors, high pressure air tanks or small explosive charges). On activation many different toughened air bladders may be inflated which may be located on the bottom and on a portion of the side of the aircraft/spacecraft/object. The bladders may inflate to an appropriate thickness (i.e. many feet) allowing the aircraft to land on a cushion of air. Based on the crash scenario, the air bladders (i.e. bottom and side) may be inflated independently. The maximum inflation pressure, shape and configuration of the individual bladders may be designed for each type of aircraft/spacecraft/object to minimize injury and to maintain aerodynamic control. The base of the bladder may remain firmly affixed to the aircraft/spacecraft/object. The air pressure in the different bladders may be independently increased or decreased in real time to minimize injury and to maintain aerodynamic control. Electronic control may be accomplished by a net of sensors in conjunction with flight parameters. This may enable the system to compensate for the position of the aircraft/spacecraft/object on impact. Due to accidental activation or other unforeseen reasons, the bladders may be deflated completely.

A shock absorber system may be assigned to each object (i.e. occupants in one or more seats, aircraft/spacecraft). The shock absorber system is explained for an internal seat shock absorber; but, it may be applied analogously to an external shock absorber (i.e. aircraft/spacecraft). Each shock absorber system may be mounted to the aircraft/spacecraft floor structure at one end and to the seat(s) at the other end. The location and number of the shock absorbers associated with each seat or seats may be designed based on safety, seating configuration, functionality, available space and cost. The shock absorber system may provide deceleration of the seat from its neutral position down to the floor. Only when a critical force is exerted on the shock absorber, may the shock absorber begin to undergo compression. The critical force may be adjusted to compensate for the weight of the object (i.e. occupant), the impact force of the object (i.e. aircraft/spacecraft) and other appropriate parameters. A spring may encompass the shock absorber system to reduce the force of impact on the object and to restore the object to its neutral position. The higher the seat is positioned above the floor of the aircraft/spacecraft the greater the likelihood of survival. A mechanically or an electromechanically controlled shock absorber may be used to decelerate the seat occupant. A net of sensors may measure the real time seat parameters. Instead of mounting the shock absorber system to the floor, it may be attached to the ceiling of the aircraft/spacecraft; but, this may involve extra support structure in the ceiling. The shock absorber system may be mounted to the floor alone, to the ceiling alone or to the floor/ceiling in conjunction with one another. Additional shock absorbers may also be mounted to provide compensation for any of the dimensions on impact (i.e. for forward velocity). The additional shock absorbers may require a special interface to the object's shock absorbers to withstand the possible high acceleration forces. A heavy duty roller bearing structure or a magnetically levitated structure may meet this requirement. The object (i.e. seat) shock absorbers may attach to the interface which in turn may drive the additional shock absorbers (i.e. parallel to the floor). Shock absorber systems may be attached both internally and externally to work in conjunction with the airbag system. An internal airbag system associated each occupant's appropriately designed seat may be inflated in conjunction with the external airbag system. The seat parameters (i.e. weight of occupant), the aircraft/spacecraft/object parameters, the internal/external airbag parameters, the internal/external shock absorber parameters and any other appropriate sensor parameters before and during impact may provide the information to accurately adjust the internal/external shock absorbers and internal/external airbags in real time.

It is important that the seat may rotate backward so that the spine is at a non vertical angle with respect to the floor (assuming this is the direction of the impact velocity). This minimizes the force exerted on the spine during impact and spreads the force out over a larger portion of the body. The seat occupant may be restrained which may be a seat belt or a six point restraint. The restraint may have a thick cushioning material encompassing its various parts. An effective cushioning material may be integrated into the seat to maximize the distribution of the force exerted on the body. The seat may incorporate a toughened air bladder that is inflatable prior to the crash or that is permanently inflated. A neck stabilizing system may be associated with each seat.

2. Deceleration of Ground Vehicles/Trains by a Bumper System

Approximately 45,000 Americans lose their lives every year on highways in the United States. An improved bumper design may benefit the occupants of both vehicles in an accident. Similar technology may be applied to trains. The bumper needs to be placed an appropriate distance in front of the leading edge of the main structure of the vehicle. Connect the bumper to the main structure of the vehicle with a number of appropriately adjusted shock absorbers. A spring may encompass each vehicle shock absorber to reduce the force of impact and to restore the bumper to its neutral position. The vehicle shock absorbers may be attached to the bumper by ball type joints to allow for some differential movement of the shocks. The bumper system may integrate structurally into the main portion of the vehicle/train so that it may withstand a head-on impact. A seat belt with a thick cushioning material may help to soften the impact. On impact the bumper may be pushed toward the vehicle/train allowing for a more gradual deceleration. In general the larger the distance separating the bumper from the main structure of the vehicle/train the greater the chance of survival. The vehicle bumper system may be mechanical or electromechanical. The shock absorbers may be mechanical or electromechanical. Real time control may provide a more accurate deceleration to minimize injury and damage. This technology may be applied to the rear bumper or to the side of the vehicle/train. The total length and total width of the vehicle/train need to be considered in this design. The vehicle/train bumpers may be expanded/retracted on command or may be fixed in an appropriate position. This technology may be integrated aesthetically into the vehicle/train. The vehicle/train bumper system may include external airbags deployable before impact to further reduce the force of the collision. This may act to protect vehicles/trains and pedestrians from being impacted by the full force of the moving vehicle/train. Cameras or other sensors may control the response (i.e. timing bumper deceleration, airbag inflation pressure) of the bumper system. Cameras sensitive to many different wavelengths of electromagnetic radiation may be fused by the electronics for a more accurate evaluation of the scene.

The train engineer usually has considerable time to respond to an imminent accident. On command from the train engineer, a large structure at the front of the lead locomotive may be moved by one or more pistons to an appropriate location (i.e. several tens of feet) in front of the train. For instance the whole nose of a train backed by a large plate would be moved forward. The pistons may be attached to the large plate by ball type joints to allow for some differential movement of the plate. The bumper system may integrate structurally into the lead locomotive so that it may withstand a head-on impact. On impact the large plate may press the pistons back toward the locomotive permitting a more gradual deceleration of the train. The entire process may be electronically controlled through a net of sensors. Pressure sensitive valves may be adjusted in real time. The last car of the train may have a similar type of mechanism. This type of mechanism may reduce casualties and minimize damage. The slower the locomotive is moving and the less weight the locomotive is pulling, the more protection is offered by the train bumper system.

3. Electromechanical Shock Absorber

The electromechanical shock absorber may be substituted for any commercial, industrial or military shock. The electromechanical shock absorber may control in real time the size of one or more orifices that allow the gas/fluid to flow across the piston or across any interface. Real time control may provide exquisite programmable operation as well as enabling many innovative applications. Backup mechanical operation may be available on electronic failure. Depending on the particular application, power may be supplied to the shock absorber by appropriate means (i.e. direct wire connection, sliding metal contact or electromagnetic transmission). The shock absorber may be powered by an external energy source, an internal energy source or a combination of external/internal energy sources. In all cases the shock absorber may be composed of the appropriate material for proper functioning.

1. A system which may include:
inflating an internal/external airbag system (i.e. ruggedized air bladders) to an appropriate thickness, associated with an aircraft/spacecraft/object (i.e. fixed wing, rotary wing, airship, satellite, spaceship) to minimize damage and/or casualties;
one or more internal/external shock absorbers, associated with an object that benefits from reduced deceleration (i.e. occupants in one or more seats, aircraft, spacecraft) to minimize damage and/or casualties;
a well designed seat (i.e. for human or object) to minimize damage and/or casualties.

2. Referring to claim 1, the external airbag system may be inflated by activating an appropriate mechanism (i.e. air compressors, pressurized tanks, explosive charges).

3. Referring to claim 1, the maximum inflation pressure, shape and configuration of the individual bladders may be designed for each type of aircraft to minimize casualties and damage.

4. Referring to claim 1, the base of the airbags may be firmly attached to the aircraft.

5. Referring to claim 1, the air pressure in the different bladders may be independently increased or decreased in real time to minimize damage and casualties.

6. Referring to claim 1, due to accidental activation or other unforeseen reasons, the air bladders may be deflated completely.

7. Referring to claim 1, an appropriate number of shock absorbers may be assigned to each object (i.e. seat, aircraft, spacecraft).

8. Referring to claim 1, a shock absorber may be mounted to the aircraft floor on one end and to the seat at the other end.

9. Referring to claim 1, the location and number of shock absorbers associated with each seat or seats may be designed based on safety, seating configuration, functionality, available space and cost.

10. Referring to claim 1, the shock absorbers may provide deceleration of the seat from its neutral position down to the floor.

11. Referring to claim 1, only when a critical force is exerted on the shock absorber, may the shock absorber begin to undergo compression.

12. Referring to claim 1, the critical force for shock absorber movement may be adjusted to compensate for the weight of the object (i.e. occupant), the impact force of the object (i.e. aircraft/spacecraft) and other appropriate parameters.

13. Referring to claim 1, a spring may encompass the shock absorber to reduce the force of impact on the object and to restore the object to its neutral position.

14. Referring to claim 1, the shock absorbers may be mechanical or electromechanical.

15. Referring to claim 1, the seat shock absorbers may be mounted to the floor alone, the ceiling alone or the floor/ceiling in conjunction with one another.

16. Referring to claim 1, the object's shock absorbers (i.e. seat) may attach to an interface structure (i.e. heavy duty roller bearing structure, magnetically levitated structure) which in turn may drive additional shock absorbers (i.e. parallel to the floor) to reduce (further reduce) the casualties and damage in other dimensions (in the same dimensions).

17. Referring to claim 1, the seat parameters (i.e. weight of occupant), the aircraft/spacecraft/object parameters, the internal/external airbag parameters, the internal/external shock absorber parameters and any other appropriate sensor parameters before and during impact may provide the information to accurately adjust the shock absorbers and airbags in real time.

18. Referring to claim 1, the seats may rotate backward to minimize the force of impact on the spine.

19. Referring to claim 1, the occupant may be protected by a restraint system (i.e. seatbelt or six point restraint) that has a thick cushioning material encompassing its various parts.

20. Referring to claim 1, the seats may have a thick cushioning material integrated into the seats to minimize the force of impact.

21. Referring to claim 1, the seat may incorporate a toughened air bladder that is inflatable prior to the crash or that is permanently inflated.

22. Referring to claim 1, a neck stabilizing system may be associated with each seat.

23. A bumper system, which may include one or more shock absorbers, associated with ground vehicles/trains may be designed to minimize damage and casualties in an accident.

24. Referring to claim 23, on command a large structure or bumper at the front of the lead locomotive or the back of the last railcar may be moved by one or more pistons to an appropriate distance from the train.

25. Referring to claim 23, the bumper may be designed an appropriate distance from the main structure of the vehicle.

26. Referring to claim 23, connect the bumper to the main structure of the vehicle with one or more shock absorbers.

27. Referring to claim 23, springs may encompass one or more shock absorbers to reduce the force of impact and to restore the vehicle bumper to its neutral position.

28. Referring to claim 23, the shock absorbers may attach to the vehicle bumper by ball type joints to allow for some differential movement of the shocks.

29. Referring to claim 23, the seat occupants of the vehicle/train may be protected by a restraint system (i.e. seatbelt, six point restraint) that has a thick cushioning material encompassing its various parts.

30. Referring to claim 23, the bumper system and shock absorbers of the vehicle may be mechanical or electromechanical.

31. Referring to claim 23, the vehicle/train bumper system may be under real time electronic control receiving input data from the sensors.

32. Referring to claim 23, the vehicle bumper system may be expanded/retracted on command or may be fixed in an appropriate position.

33. Referring to claim 23, the bumper system may be applied to the front, rear or sides of the vehicle/train.

34. Referring to claim 23, the bumper system may include external airbags deployable before impacting an object (i.e. vehicle, pedestrian) to reduce the force of the collision.

35. Referring to claim 23, the bumper system may include fused input from different wavelength cameras and other types of sensors to accurately control the response (i.e. timing, bumper deceleration, airbag inflation pressure) of the bumper system.

36. An electromechanical shock absorber may control in real time the size of one or more orifices that allow the gas/fluid to flow across the piston or across any interface which may provide exquisite programmable operation.

37. Referring to claim 36, backup mechanical operation may be available on electronic failure.

38. Referring to claim 36, the power to the shock absorber may be supplied by an external energy source (i.e. direct wire connection, sliding metal contacts, electromagnetic transmission), by an internal energy source or by a combination of external/internal energy sources.
